(19) United States
(12) Patent Application Publication
(10) Pub. No.: US 2025/0154056 A1
(43) Pub. Date: May 15, 2025

(54) CARBONATED BIOMASS ASH AS A SUBSTITUTE CEMENTITIOUS MATERIAL

(71) Applicant: VICAT, L'lsle-d'Abeau (FR)

(72) Inventors: Laury BARNES-DAVIN, Voiron (FR); Virginie NOWALSKI, Chassignieu (FR)

(73) Assignee: VICAT, L'lsle-d'Abeau (FR)

(21) Appl. No.: 18/838,256

(22) PCT Filed: Feb. 16, 2023
(86) PCT No.: PCT/FR2023/050208

§ 371 Date: Aug. 14, 2024

(30) Foreign Application Priority Data
Feb. 17, 2022 (FR) FR22/01386

(51) Int. Cl. C04B 7/26; C04B 28/02; C04B 111/00

(52) U.S. Cl. CPC C04B 7/26; C04B 28/021; C04B 2111/00215

(57) ABSTRACT

A method of producing a cementitious material substitute includes preparing a carbonated biomass ash.

The present invention relates to the use of carbonated biomass ash as a cementitious material substitute.

The manufacture of binders, in particular the hydraulic binders, and in particular that of cements, essentially consists in calcining a mixture of carefully selected and dosed raw materials, also called «raw-mix». The cooking of this raw material produces an intermediate product, the clinker, which, when milled with calcium sulfate and possible mineral additions, will produce cement. The type of manufactured cement depends on the nature and proportions of the raw materials as well as the cooking method. There are several types of cements: Portland cements (which represent most of cements produced in the world), aluminous cements (or calcium aluminate), natural quick setting cements, sulpho-aluminous cements, sulfo-belitic cements and other intermediate varieties.

The most widely used cements are the Portland type cements. The Portland cements are obtained from Portland clinker, obtained after clinkering at a temperature in the range of 1450° C. from a raw-mix material rich in calcium carbonate in a furnace. The production of one ton of Portland clinker is accompanied by the emission of significant quantities of CO₂ (about 0.8 to 0.9 tons of CO₂ per ton of cement in the case of a clinker).

Yet, in 2014, the amount of cement sold worldwide was around 4.2 billion tons (source: French Trade Union for the Cement Industry—SFIC). This figure, which is constantly increasing, has more than doubled in 15 years. The cement industry is therefore today looking for a valid alternative to Portland cement, that is to say cements having at least the same strength and quality features as Portland cements, but which, during their production, emit less CO₂.

During the production of clinker, the main constituent of Portland cement, the release of CO₂ is linked to:
up to 40% for heating the cement kiln, in milling and in transport;
up to 60% of so-called chemical CO₂, or of decarbonation CO₂.

The decarbonation is a chemical reaction that takes place when limestone, the main raw material for the manufacture of Portland cement, is heated at high temperatures. The limestone is then transformed into quick lime and CO₂ according to the following chemical reaction:

CaCO₃→CaO+CO₂

The natural carbonation of cement-based materials, particularly concretes, is a potential way to reduce the carbon footprint linked to the manufacturing process and use of cement. However, although concrete prepared from these cements are naturally recarbonated during the life of the structures to the tune of 15% to 20% of the CO₂ emitted during the manufacturing, the carbon balance associated with the production of Portland cement remains positive. It therefore remains necessary to reduce CO₂ emissions during the production of Portland cement and/or to improve end-of-life concrete recovery methods.

To reduce the CO₂ emissions related to the production of Portland cement, several approaches have been considered so far:
adapting or modernizing cement methods in order to maximize the efficiency of heat exchanges;
developing new «low carbon» binders such as sulpho-aluminous cements prepared from raw materials less rich in limestone and at a lower cooking temperature, which allows a reduction in CO₂ emissions of about 35%;
or even more (partial) substituting clinker in cements with materials making it possible to limit CO₂ emissions.

Among the above approaches, that of (partial) substitution of clinker in cements has been the subject of numerous developments.

Among the used substitute materials, it can notably cited slag from blast furnaces and fly ash from coal-fired power stations. However, the closure of coal-fired power stations is causing a shortage of good quality fly ash. Furthermore, the substitution of clinker with limestone filler (that is to say an inactive material) essentially has a dilution effect and is accompanied by a significant drop in strength, which is problematic.

Carbon capture and storage technologies have also been developed to limit the CO₂ emissions from cement plants or coal-fired power plants. International patent application WO-A-2019/115722 describes a method allowing both the cleaning of CO₂-containing exhaust gases and the manufacture of additional cementitious material. The described method involves using recycled concrete fines comprising the provision of recycled concrete fines with d₉₀≤1000 μm into stocks or a silo as a starting material, rinsing the starting material to provide a carbonaceous material, the removal of the carbonaceous material and the cleaned exhaust gas, and the deagglomeration of the carbonaceous material to form the additional cementitious material, as well as the use of stocks or a silo containing a starting material of recycled concrete fines with d₉₀≤1000 μm for cleaning CO₂-containing exhaust gases and the simultaneous manufacture of an additional cementitious material. However, this method requires drying the carbonated product before it can be used.

At the date of the present invention, it therefore remains necessary to identify new substitute materials making it possible to significantly reduce the CO₂ emissions during the production of cement while maintaining the mechanical properties of the construction materials prepared from these cements, in particular medium and long-term compressive strengths, at levels allowing their use.

The biomass ash, that is to say the ash obtained from the combustion of biomass such as wood, so-called annual plants, agricultural residues, paper and wastewater treatment plant sludge (or STEP sludge) are valued through their use in different fields. Thus, it is noted that biomass ash are used in particular to stabilize foundation soils, for the treatment of liquid effluents or even as a secondary raw material in ceramic products or as a mineral filler in bituminous coatings.

The use of carbonated biomass ash in the form of monoliths as a substitute for light aggregates was studied by Hills Colin et al. in their publication «Valorisation of agricultural biomass-ash with CO₂», Scientific Reports, vol. 10, no 1, 1 Dec. 2020. The use of such ash as a cementitious substitute, or, more generally, as a binder substitute, is never mentioned by the authors. Moreover, the solution presented in this document only makes it possible to reduce the carbon footprint associated with the production of the construction material due to the capture of CO₂ by the aggregate used to prepare it (the production of said aggregates does not produce (or little) CO₂.

The use of biomass ash as alternatives to coal fly ash as a substitute material in cementitious compositions was also evaluated. However, several authors, such as Ivana Carević et al., «Correlation between physical and chemical properties of wood biomass ash and cement composites performances», Construction and Building Materials, Vol. 256, 30 Sep. 2020, 119450, have found that the use of these ash in cements or concretes leads to a loss of workability which makes the implementation of the cement or concrete difficult. The workability can be partially restored by increasing the amount of mixing water, but this increase in the W/C ratio results in a loss of mechanical strength.

This workability issue is also reported in Japanese patent application JP-A-2021-155720. The purpose of this patent application is to provide a method for preparing a construction material capable of capturing/immobilizing the CO₂ quickly. A method for preparing a construction material comprising a step of carbonating an alkaline solid containing calcium then a mixing with a cement is described in particular. It is nevertheless explained that the use of alkaline solids containing calcium in cements is associated with workability problems and that the use of coal ash (i.e. fly ash) should be preferred in order to limit this effect.

Yet, it has now been found quite surprisingly that the carbonation of biomass ash allows their use as a cementitious addition without this reducing the workability of the cement or concrete finally prepared. Furthermore, it has also been observed that carbonated biomass ash do not behave like simple fillers but contribute to increasing the performance of the binder, which makes it possible to significantly increase the substitution rate of said binder compared to conventional filler, thus making it possible to significantly reduce the carbon footprint of the construction material finally prepared while maintaining mechanical properties, and in particular medium and long-term compressive strengths compatible with the intended uses. The use of carbonated biomass ash as a cement substitute therefore makes it possible to lower the carbon footprint associated with the production of the construction material not only by the capture of CO₂ by the biomass ash, but also by the significant reduction in the amount of clinker to be produced to obtain said construction material.

Thus, the present invention relates to the use of carbonated biomass ash as a cementitious material substitute.

The use of carbonated biomass ash makes it possible to significantly increase the cement substitution rate compared to conventional fillers, and therefore to significantly lower the carbon footprint of the construction material finally prepared from said binder, and while maintaining a workability and mechanical properties, and in particular medium and long-term compressive strengths compatible with the intended uses

In the context of the present invention:
the term «biomass ash» means any mainly basic residue from the combustion of various plant, natural and non-fossil organic materials such as wood, so-called annual plants, agricultural residues, paper and wastewater treatment plant sludge (or STEP sludge) containing less than 11% total carbon, less than 4% inorganic carbon, and at least 1% Na₂O equivalent. Preferably, the biomass ash further contain at least one of the following phases: whitlockite, hydroxyapatite, tremolite and/or tricalcium phosphate;
the term «carbonated biomass ash» means any biomass ash which, after being brought into contact with a CO₂-enriched gas flow, retains part of it and contains more than 4% inorganic carbon;

the term «aluminous cement» means any cement, amorphous or not, obtained by cooking a mixture of limestone and bauxite and containing at least 5% monocalcium aluminate CA; 20
the term «quick natural cement» means any hydraulic binder with rapid setting and hardening according to standard NF P 15-314:1993 in force on the date of the present invention. Preferably, «quick natural cement» designates a cement prepared from a clinker comprising:
from 0% to 20% of C₃S;
from 40% to 60% of C₂S;
from 7% to 12% of C₄AF;
from 2% to 10% of C₃A;
from 10% to 15% of CaCO₃ (calcite);
from 10% to 15% of Cas (SiO₄)₂CO₃ (spurrite);
from 3% to 10% of sulfate phases: yeelimite C₄A₃$, langbeinite (K₂Mg₂(SO₄)₃, anhydrite (CaSO₄); and
from 10% to 20% lime, periclase, quartz and/or one or more amorphous phases;
the term «Portland cement» means any Portland clinker-based cement classified as CEM (I, II, III, IV or V) according to standard NF EN 197-1;
the term «sulfo-aluminous cement» means any cement prepared from a sulfo-aluminous clinker containing 5% to 90% of ‘yeelimite’ phase C₄A₃$, a source of sulfate, and, optionally, a limestone addition;
the term «cement composition» means any composition based on cement or an alkali-activated binder and free of aggregates, preferably any composition comprising an aluminous cement, a quick natural cement, a Portland cement and/or a sulpho-aluminous cement and free of aggregates, capable of being used for the preparation of a construction material;
the term «cementitious material substitute» means any composition capable of partly replacing a cementitious composition in the preparation of a construction material while contributing to the increase in performance of the cementitious binder resulting from this combination;
the term «Na₂O equivalent» or «Na₂O eq.» means the alkali content of a cement calculated according to the following formula: % Na₂O eq.=(% Na₂O+0.658% K₂O) soluble in acid;
the term «loss on ignition» means the cumulative content of bound water, organic matter, CO₂ of carbonates (limestone fillers and carbonated part of the material) and possible oxidizable elements. The loss on ignition is determined by calcination in air at a temperature of (950+/−25° C.) according to the method described in standard NF EN 196-2 (classification index P 15-472)-Cement testing methods-Part 2: Chemical analysis of cements; and
the term «construction material» means mortar or concrete.

In the context of the present invention, the following notations are adopted to designate the mineralogical components of cement:
C represents CaO;
A represents Al₂O₃;
F represents Fe₂O₃;
S represents SiO₂; and
$ represents SO₃.

In the context of the present invention, the «inorganic carbon rate» or «CIT» corresponds to the amount (% w/w) of inorganic carbon contained in an entity (e.g. carbonated biomass ash) relative to the total weight of said entity (e.g. said carbonated biomass ash).

To determine the level of inorganic carbon, different methods can be used, such as for example a previously calibrated Carbon Hydrogen Sulfur (CHS) elemental analyzer. To do this, approximately 250 mg of the product to be analyzed is placed in a nickel boat. This boat is then introduced into a tubular quartz furnace allowing a gradual rise in temperature and stages in temperature in order to separate the different carbon species in a sample. It can thus be determined:
the «COT», namely the amount (% w/w) of total organic carbon of the entity determined by analysis of the signal obtained between 100° C. and 400° C. with a temperature hold at 400° C.;
the «C», namely the amount (% w/w) of elemental carbon of the entity determined by analysis of the signal obtained between 400° C. and 600° C. with a temperature hold at 600° C.; and
the «CIT», namely the amount (% w/w) of total inorganic carbon of the entity determined by analysis of the signal obtained between 600° C. and 1000° C. with a temperature hold at 1000° C.

The total carbon «CT» corresponds to the sum of these three values: CT=COT+C+CIT

Finally, in the context of the present invention, the proportions expressed in % correspond to weight percentages relative to the total weight of the considered entity (e.g. ash).

The subject of the present invention is therefore the use of carbonated biomass ash as a cementitious material substitute. Preferably, the carbonated biomass ash possess the following characteristics, selected alone or in combination:
carbonated biomass ash contain at least 4.5% of inorganic carbon; preferably the carbonated biomass ash contain at least 5% of inorganic carbon; very preferably, the carbonated biomass ash contain at least 5.5% of inorganic carbon;
carbonated biomass ash contain less than 10% of lime; preferably the carbonated biomass ash contain less than 5% of lime; very preferably, the carbonated biomass ash contain less than of 3% lime;
carbonated biomass ash contain more than 2% of carbonates; preferably the carbonated biomass ash contain more than 15% of carbonates; very preferably, the carbonated biomass ash contain more than 25% of carbonates;
carbonated biomass ash contain less than 60% of SiO₂; preferably the carbonated biomass ash contain less than 40% of SiO₂; very preferably, the carbonated biomass ash contain less than 30% of SiO₂;
carbonated biomass ash contain less than 40% of Al₂O₃; preferably carbonated biomass ash contain less than 30% of Al₂O₃; very preferably, the carbonated biomass ash contain less than 20% of Al₂O₃;
carbonated biomass ash contain calcite, kalcinite, carbo-hydroxyapatite and/or hydrocalumine; and/or
carbonated biomass ash have a loss on ignition of at least 5%; preferably the carbonated biomass ash have a loss on ignition of at least 15%; very preferably, the carbonated biomass ash have a loss on ignition of at least 20%;

The carbonated biomass ash according to the present invention make it possible to achieve substitution rates of up to 45% of the cementitious composition, preferably up to 40% of the cementitious composition, most preferably up to 35% of the cementitious composition, while maintaining mechanical properties, and in particular medium and long-term compressive strengths of the construction material finally prepared, compatible with the intended uses.

The carbonated biomass ash used in the context of the present invention can be obtained by any method known to those skilled in the art. By way of example, it can in particular be cited a method for preparing carbonated biomass ash comprising the following steps:
introducing biomass ash into a rotary drum, mixer, container or fluidized bed type reactor;
bringing the ash into contact with a source of CO₂ such as exhaust gas from a cement plant or a thermal power plant; and
recovering the obtained carbonated biomass ash.

The present invention can be illustrated in a non-limiting manner by the following examples.

### Example 1—Carbonated Biomass Ash

Different carbonated biomass ash are obtained by placing a mixture of approximately 250 g of ash obtained by combustion of different biomasses and 15% by mass of water ash in a hermetically sealed bowl which is itself fixed on the base of a heated mixing robot.

The compositions and features of the used biomass ash (Ash 1 to 4) before carbonation are reported in Table 1 below, in comparison with the composition and features of fly ash (non-carbonated) usually used in the cement industry.

TABLE 1
Composition and features of biomass ash before carbonation

| | Composition (% (w/w)) | | | | |
|---|---|---|---|---|---|
| | Wood | Wood | Paper | Paper | Type C |
| | ash | ash | Ash | ash | coal fly |
| Features | (Ash 1) | (Ash 2) | (Ash 3) | (Ash 4) | ash (Ref.) |
| CaO | 31 | 21 | 54 | 63 | 18.3 |
| SiO₂ | 4 | 2 | 20 | 10 | 43.5 |
| Al₂O₃ | 1 | 2 | 9 | 67 | 20.4 |
| Fe₂O₃ | — | 1 | 1 | 1 | 5.4 |
| SO₃ | 12 | 14 | 2 | 1 | 1.8 |
| P₂O₅ | 4 | 3 | 1 | — | — |
| Na₂O | 1 | 1 | 1 | 1 | 1.5 |
| K₂O | 25 | 26 | 1 | 1 | — |
| MgO | 5 | 3 | 2 | 2 | 4.3 |
| TiO₂ | — | — | 1 | — | — |
| Loss on ignition | 15 | 20 | 8 | 14 | 0.9 |
| CIT | 3.4 | 3.1 | 1.9 | 3.9 | — |

The reactor is equipped with a cup containing water to regulate the relative humidity in the reactor.

The temperature of the bowl is maintained at 55° C. The bowl cover is equipped with 2 orifices which allow the injection of a gas and its evacuation.

The gas is injected for a mixing time of 1 hour and is made up of 100% CO₂.

The biomass ash thus carbonated have the following features (Table 2), in comparison with non-carbonated biomass ash.

TABLE 2
Ash/carbonate ash

| | | CIT (%) |
|---|---|---|
| Ash 1 | Before carbonation | 3.4 |
| | Carbonated | 4.8 |
| Ash 2 | Before carbonation | 3.1 |
| | Carbonated | 8.6 |
| Ash 3 | Before carbonation | 1.9 |
| | Carbonated | 4.8 |
| Ash 4 | Before carbonation | 3.9 |
| | Carbonated | 7.8 |

### Example 2—Cementitious Compositions According to the Invention

A reference Portland cement of class CEM I 52.5 R is mixed with different quantities of non-carbonated or carbonated ash from Example 1.

The compositions of cementitious compositions 2 to 5 (compositions according to the invention) and 6 to 9 (cementitious compositions prepared from non-carbonated ash) thus obtained are reported in the following Tables 3.1, 3.2 and 3.3.

TABLE 3.1
Cementitious compositions 1 to 9

| Cementitious | | | | | | | | | |
|---|---|---|---|---|---|---|---|---|---|
| composition | 1 | | | | | | | | |
| (% w/w) | (Ref.) | 2 | 3 | 4 | 5 | 6 | 7 | 8 | 9 |
| CEM I 52, 5 | 100 | 75 | 75 | 75 | 75 | 75 | 75 | 75 | 75 |
| Carbonated | 0 | 25 | 0 | 0 | 0 | 0 | 0 | 0 | 0 |
| ash 1 | | | | | | | | | |
| Carbonated | 0 | 0 | 25 | 0 | 0 | 0 | 0 | 0 | 0 |
| ash 2 | | | | | | | | | |
| Carbonated | 0 | 0 | 0 | 25 | 0 | 0 | 0 | 0 | 0 |
| ash 3 | | | | | | | | | |
| Carbonated | 0 | 0 | 0 | 0 | 25 | 0 | 0 | 0 | 0 |
| ash 4 | | | | | | | | | |
| Non-carbonated | 0 | 0 | 0 | 0 | 0 | 25 | 0 | 0 | 0 |
| ash 1 | | | | | | | | | |
| Non-carbonated | 0 | 0 | 0 | 0 | 0 | 0 | 25 | 0 | 0 |
| ash 2 | | | | | | | | | |
| Non-carbonated | 0 | 0 | 0 | 0 | 0 | 0 | 0 | 25 | 0 |
| ash 3 | | | | | | | | | |
| Non-carbonated | 0 | 0 | 0 | 0 | 0 | 0 | 0 | 0 | 25 |
| ash 4 | | | | | | | | | |

TABLE 3.2
Cementitious compositions 1 to 9 (phasic composition)

| Cementitious | | | | | | | | | |
|---|---|---|---|---|---|---|---|---|---|
| composition (% w/w) | 1 | 2 | 3 | 4 | 5 | 6 | 7 | 8 | 9 |
| C₃S | 61.2 | 48.6 | 47.3 | 46.5 | 46.8 | 48.6 | 48.1 | 46.7 | 46.8 |
| C₂S Alpha′H | 2.8 | 2.8 | 2.3 | 5.3 | 2.8 | 2.6 | 2.2 | 6.3 | 5.9 |
| C₂S beta | 7.0 | 7 | 6.2 | 7.8 | 7.5 | 6.4 | 6.9 | 8.5 | 7.6 |
| C₃A | 3.3 | 3.3 | 3.1 | 2.9 | 2.9 | 3.1 | 2.5 | 2.9 | 2.9 |
| C₄AF | 12.2 | 9 | 8.3 | 9.3 | 9 | 9.2 | 9.8 | 9.1 | 9 |
| C₁₂A₇ | 0.5 | 0.5 | 0.5 | 0.7 | 0.6 | 1.1 | 0.8 | 0.7 | 1.6 |
| Calcite | — | 5.2 | 6.1 | 12.5 | 19.6 | 2.6 | 4.9 | 3.9 | 8.5 |
| Kalicinite | — | 3.3 | — | — | — | 0 | — | — | — |
| Sylvite | — | — | — | — | — | — | 0.5 | — | — |
| Lime | 0.1 | 0.1 | 0.2 | 0.7 | 0.3 | 0.9 | — | 5.6 | 6.5 |
| Periclase | 0.9 | 0.5 | 1.4 | 0.6 | 0.4 | 1.4 | 0.6 | 0.8 | 0.5 |
| Hydroxyapatite | — | — | — | — | — | 2.1 | 1.7 | — | — |
| Carbo-hydroxyapatite | — | 2 | 2.7 | — | 0.2 | — | — | — | — |
| Hydrocalumite | — | — | — | 0.7 | 0.5 | — | — | — | — |
| Quartz | 0.6 | 0.2 | 0.1 | 1.6 | 0.4 | 0.3 | 0.3 | 1.7 | 0.9 |
| Anhydrite | 0.9 | 1 | 1.1 | 1.3 | 1 | 1.2 | 1.1 | 1.4 | 1.1 |
| Bassanite | 1.8 | 1.6 | 1.3 | 1.5 | 1.5 | 1.8 | 2 | 1.5 | 1.5 |
| Gypsum | 2.3 | 2 | 1.9 | 1.2 | 1.2 | 2.2 | 1.9 | 1.2 | 1.2 |
| Syngenite | 1.7 | 1.3 | 1.5 | — | — | 1.5 | 1.4 | — | — |
| Aphtithalite | 1.2 | 0.3 | 0.3 | 0.2 | 0.2 | 0.5 | 0.4 | 0.2 | 0.2 |
| Arcanite | 1.0 | 8.9 | 10.8 | 0.3 | 0.3 | 6.9 | 8.9 | 0.3 | 0.3 |
| Ca-Langbeinite | 0.3 | 0.1 | 0.2 | — | — | 0.3 | — | — | — |
| Portlandite | 0.2 | 2.1 | 1.8 | 1.9 | 1.6 | 5 | 4.6 | 1.8 | 1.6 |
| Amorphous | — | 7 | 6.7 | 5.7 | 5.3 | 6.5 | 6.3 | 5.1 | 3.6 |

TABLE 3.3
Cementitious compositions 1 to 9 (elemental analysis)

| Cementitious composition (% w/w) | 1 | 2 | 3 | 4 | 5 | 6 | 7 | 8 | 9 |
|---|---|---|---|---|---|---|---|---|---|
| SiO₂ | 20.3 | 15.9 | 15.6 | 19.8 | 17.6 | 16.1 | 15.8 | 20.1 | 17.8 |
| Al₂O₃ | 4.6 | 3.7 | 3.9 | 5.5 | 4.9 | 3.8 | 4 | 5.8 | 5.3 |
| Fe₂O₃ | 3.3 | 2.5 | 2.7 | 2.7 | 2.6 | 2.6 | 2.7 | 2.7 | 2.6 |
| CaO | 61.6 | 52.4 | 51 | 57.3 | 57.8 | 53.1 | 51.3 | 59.8 | 61.9 |
| MgO | 1.9 | 2.4 | 2.2 | 1.9 | 1.7 | 2.6 | 2.2 | 1.9 | 1.8 |
| SO₃ | 3.6 | 5.2 | 6.4 | 3.2 | 3 | 5.4 | 6.5 | 3.3 | 3 |
| K₂O | 1.0 | 7 | 7.7 | 0.9 | 1 | 7.1 | 8.1 | 0.9 | 0.8 |
| Na₂O | 0.2 | 0.4 | 0.5 | 0.3 | 0.4 | 0.4 | 0.5 | 0.3 | 0.4 |
| SrO | 0.1 | 0.1 | 0.1 | 0.1 | 0.1 | 0.1 | 0.1 | 0.1 | 0.1 |
| TiO₂ | 0.3 | 0.2 | 0.2 | 0.4 | 0.3 | 0.2 | 0.2 | 0.5 | 0.3 |
| P₂O₅ | 0.2 | 0.9 | 1 | 0.4 | 0.2 | 1 | 1 | 0.4 | 0.1 |
| MnO | 0.07 | 0.3 | 0.4 | 0.1 | 0.1 | 0.3 | 0.43 | 0.1 | 0.1 |
| Na₂O eq. | — | 5 | 5.5 | 0.9 | 1 | 5.5 | 5.8 | 0.9 | 1 |
| Loss on | 1.86 | 8.6 | 7.6 | 5.3 | 8.4 | 6.1 | 6.7 | 1.9 | 3.6 |
| ignition | | | | | | | | | |
| (950° C.) | | | | | | | | | |

The gain in CO₂ emissions for the cement compositions 2 to 5 compared to the reference cement composition 1 is reported in the following Table 4.

TABLE 4
CO₂ gain for cementitious compositions 2 to 5

Cementitious composition

| | 2 | 3 | 4 | 5 |
|---|---|---|---|---|
| CO₂ gain compared to the | 213 | 201 | 219 | 226 |
| reference (KgCO₂ eq/t) | | | | |

### Example 3—Workability (Spreading)

A spreading measurement was carried out in accordance with standard EN 1015-3 on 3 mortars manufactured according to standard 196-1 by mixing 450 g of binder 1, 4 or 8, 1350 g of sand and 225 g of water.

The results are reported in the following Table 5.

TABLE 5
Spreading measurement for the cementitious
compositions 1, 3 and 8

| | Mortar prepared | Mortar prepared | Mortar prepared |
|---|---|---|---|
| | from cementitious | from cementitious | from cementitious |
| | composition 1 | composition 3 | composition 8 |
| Spread (in mm) | 185 | 142 | 133 |

As these results show, the use of a mixture of cement and non-carbonated ash leads to a loss of almost 30% in workability. Carbonating the ash before mixing with the cement makes it possible to limit the loss of rheology and maintain it at an acceptable level for a good implementation.

### Example 4—Mechanical Performances

The compressive strength of the cementitious compositions obtained in Example 2 was measured on prismatic specimens of standardized mortar (4×4×16 cm3), at different time periods (1, 2, 7 and 28 days) according to standard EN 196-1.

The obtained results are reported in the following Table 6.

TABLE 6
Compressive strength of cementitious
compositions 1 and 4 to 9

| Cementitious | | | | | | | |
|---|---|---|---|---|---|---|---|
| composition | 1 | 4 | 5 | 6 | 7 | 8 | 9 |
| R_{c} (in MPa) | 29.3 | 17.4 | 18.8 | — | — | — | 3 |
| at 1 day | | | | | | | |
| R_{c} (in MPa) | 41.7 | 30.7 | 35.1 | — | — | 26.1 | 7 |
| at 2 days | | | | | | | |
| R_{c} (in MPa) | 52.9 | 43.7 | 48.1 | 3.2 | 17.8 | 41.4 | 15 |
| at 7 days | | | | | | | |
| R_{c} (in MPa) | 62 | 52.5 | 51 | 3.5 | 25.5 | 43.4 | 21 |
| at 28 days | | | | | | | |

The cementitious compositions according to the invention (i.e. compositions 4 and 5) present acceptable performances with regard to those observed for the reference CEM I at all deadlines. It is thus noted that mechanical performance is maintained in the short, medium and long term at an acceptable level.

On the other hand, there is a sharp reduction in the mechanical performance of cementitious compositions containing non-carbonated biomass ash.

### Example 5—Comparative Examples

### 5.1—Coal-Type Fly Ash-Based Cementitious Composition

The coal-type fly ash whose composition is reported in Table 1 are carbonated according to the protocol of Example 1.

The cementitious composition 10 is obtained by mixing a reference Portland cement of class CEM I 52.5 R with the carbonated ash thus obtained in a proportion (% w/w) 75/25.

5.2—Carbonated Cementitious Composition after Addition of Non-Carbonated Ash

The cementitious composition 11 is obtained by carbonation according to the protocol of Example 1 of a 75/25 mixture (% w/w) of a reference Portland cement of class CEM I 52.5 R with paper ash No. 4 of Example 1 (non-carbonated ash).

### 5.3—Comparative Results

### 5.3.1—Workability (Spreading)

The workability of the cementitious composition 11 is evaluated according to the protocol of Example 3.

The mortar prepared from the cementitious composition 11 is too dry and therefore does not spread, making its implementation impossible.

### 5.3.2—Compressive Strength

The compressive strength of cementitious compositions 10 and 11 is evaluated according to the protocol of Example 4.

The obtained results are reported in the following Table 7.

TABLE 7
Compressive strength of cementitious compositions 10 and 11

Cementitious composition

| | 10 | 11 |
|---|---|---|
| R_{c} (in MPa) at 2 days | 29.5 | 14 |
| R_{c} (in MPa) at 7 days | 40.6 | 28.8 |
| R_{c} (in MPa) at 28 days | 48.5 | 30.8 |

The compressive strengths of the cement compositions prepared from fly ash from coal combustion are significantly lower than the compressive strengths of the cementitious compositions prepared from carbonated biomass ash at 2, 7 and 28 days. The obtained results for cementitious composition 11 are extremely low (loss of more than 50% of performance compared to the 100% Portland reference) and render it unusable.

1. A method of producing a cementitious material substitute comprising:
preparing a carbonated biomass ash.

2. The method according to claim 1, wherein the carbonated biomass ash contain at least 4.5% of inorganic carbon.

3. The method according to claim 2, wherein the carbonated biomass ash contain at least 5% of inorganic carbon.

4. The method according to claim 3, wherein the carbonated biomass ash contain at least 5.5% of inorganic carbon.

5. The method according to, claim 1, wherein the carbonated biomass ash contain less than 10% of lime.

6. The method according to claim 1, wherein the carbonated biomass ash contain more than 2% of carbonates.

7. The method according to claim 1, wherein the carbonated biomass ash contain less than 60% of SiO₂.

8. The method according to claim 1, wherein the carbonated biomass ash contain less than 40% of Al₂O₃.

9. The method according to claim 1, wherein the carbonated biomass ash contain calcite, kalcinite, carbo-hydroxyapatite and/or hydrocalumine.

10. The method according to claim 1, wherein the carbonated biomass ash have a loss on ignition of at least 5%.
